(19) United States
(12) Patent Application Publication
(10) Pub. No.: US 2011/0109600 A1
(43) Pub. Date: May 12, 2011

(54) Image Display Apparatus to Which Plurality of Image Sources Can Be Connected

(75) Inventors: Koki YAMAMOTO, Osaka (JP); Kenji OFUNE, Osaka (JP)

(73) Assignee: SANYO ELECTRIC CO., LTD., Osaka (JP)

(21) Appl. No.: 12/943,725

(22) Filed: Nov. 10, 2010

(30) Foreign Application Priority Data
Nov. 10, 2009 (JP) 2009-256953 P

(51) Int. Cl. G09G 5/00

(52) U.S. Cl. 345/204

(57) ABSTRACT

When a history image display mode is performed, a display region of a display unit of a projector is divided into a plurality of windows. In a main window, an image based on a currently selected image signal is displayed. In a plurality of sub windows, history images as images based on image signals selected in the past are displayed in accordance with chronological order. When a user desires to switch an input image, the user uses a remote controller or a manipulation unit to perform a manipulation to select a desired history image on a screen of the display unit. When the manipulation to select a history image is performed, the projector selects an input terminal corresponding to the selected history image, and causes an image based on an image signal from the input terminal to be displayed in the main window.

This nonprovisional application is based on Japanese Patent Application No. 2009-256953 filed on Nov. 10, 2009 with the Japan Patent Office, the entire contents of which are hereby incorporated by reference.

### BACKGROUND OF THE INVENTION

1. Field of the Invention

The present invention relates to an image display apparatus, and more particularly, to an image display apparatus to which a plurality of image sources can be connected.

2. Description of the Related Art

Some image display apparatuses are configured to be able to select an image to be displayed through a menu screen. For example, when “image selection” as a menu for selecting a content to be reproduced is selected through a menu screen displayed during manual reproduction, the image display apparatus causes a liquid crystal monitor to display a content selection screen.

Here, some image display apparatuses are configured such that a plurality of image sources (external image equipment) can be connected thereto. In particular, recently, by diversification of the types of image sources, the number of input terminals receiving image signals from the image sources tends to be increased.

When a user switches an image to be displayed on a screen through a menu screen in an image display apparatus including a plurality of input terminals as described above, it has been complicated for the user to perform a manipulation for selecting an image signal as a switching target, because the number of selection items on the menu screen is increased.

In addition, the user can know what image signal is input to a selected input terminal only after an image based on an image signal selected on the menu screen is projected. Therefore, the user has to switch an input image signal while checking which image source can be used and what is displayed, for each input terminal, and thus the manipulation has been inconvenient.

### SUMMARY OF THE INVENTION

An image display apparatus in accordance with the present invention is an image display apparatus which displays an image represented by an image signal, including a plurality of input terminals which accept a plurality of image signals externally supplied, respectively, a selection unit which selects at least one input terminal from among the plurality of input terminals, a display unit which displays an image based on an image signal from the input terminal selected by the selection unit, a history image holding unit which holds an image based on an image signal from an input terminal selected by the selection unit in the past as a history image, and a history image display unit which causes the display unit to display the history image held in the history image holding unit.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a view illustrating a configuration of peripheral apparatuses when an image is projected by an image display apparatus in accordance with an embodiment of the present invention.

FIGS. 2A and 2B are views illustrating a conventional method of switching an input image signal.

FIGS. 3(A) and 3(B) are views showing an example of images displayed by a projector in accordance with the present embodiment.

FIG. 4 is a view illustrating a configuration of the projector in accordance with the embodiment of the present invention.

FIG. 5 is a view illustrating a configuration of a memory in FIG. 4.

FIG. 6 is a view illustrating an operation of the projector in each of a single-screen display mode and a history image display mode.

FIGS. 7(A) and 7(B) are views showing another example of images displayed by the projector in accordance with the present embodiment.

FIG. 8 is a view illustrating an operation of the projector in each of the single-screen display mode and the history image display mode.

### DESCRIPTION OF THE PREFERRED EMBODIMENTS

Hereinafter, an embodiment of the present invention will be described in detail with reference to the drawings, in which identical or corresponding parts will be designated by the same reference numerals, and the description thereof will not be repeated.

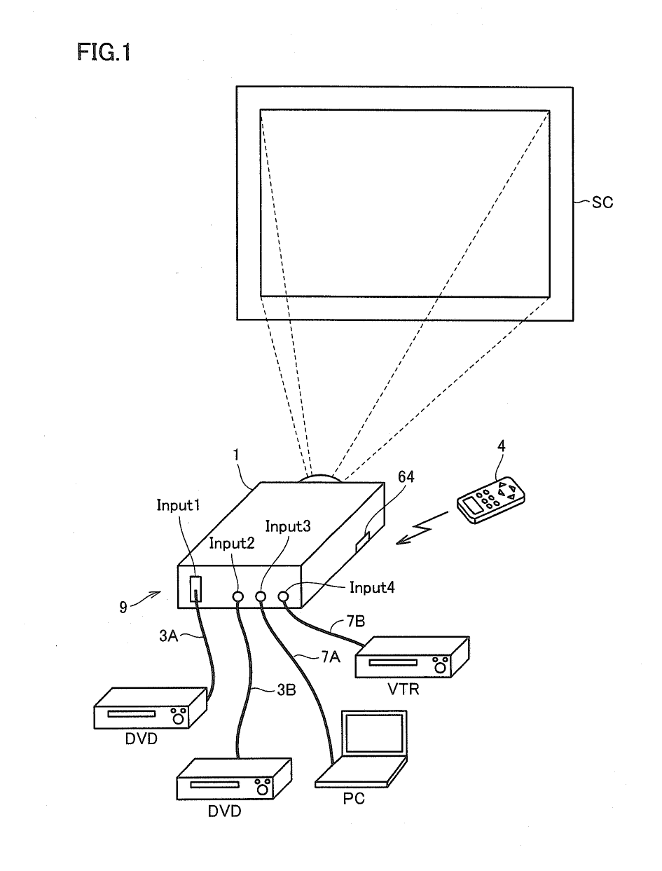

FIG. 1 is a view illustrating a configuration of peripheral apparatuses when an image is projected by an image display apparatus in accordance with an embodiment of the present invention.

Referring to FIG. 1, an image display apparatus (hereinafter also referred to as a “projector”) 1 in accordance with the present embodiment is a liquid crystal projector projecting an image utilizing a liquid crystal device, and projects (displays) the image by projecting light of the image to be displayed by the liquid crystal device on a projection screen SC. A projection surface is not limited to projection screen SC, and may be a wall surface.

Projector 1 includes a manipulation accepting unit 64 receiving an infrared modulated remote control signal transmitted from a remote controller 4 manipulated by a user, and an input unit 9. The remote control signal includes a command signal for remotely controlling projector 1.

Manipulation accepting unit 64 can not only receive the remote control signal but also accept a signal from a manipulation unit (not shown) having a plurality of manipulation buttons for manipulating projector 1 provided to a main body of projector 1.

Input unit 9 includes a plurality of input terminals. Different types of image signals can be input from the input terminals. In the present embodiment, as an example, it is assumed that input unit 9 includes four input terminals Input 1 to Input 4.

A digital transmission path and an analog transmission path are connected to input unit 9. The digital transmission path includes a communication cable 3A conforming to the DVI (Digital Visual Interface) and a communication cable 3B conforming to the HDMI (High Definition Multimedia Interface).

Communication cable 3A is connected to input terminal Input 1 of input unit 9, and transmits an image signal between an external image source and projector 1 in accordance with the DVI. Examples of an apparatus (the image source) supplying an image signal in accordance with the DVI specification (hereinafter also referred to as a DVI signal) include an image source outputting a digital signal, such as a DVD (Digital Versatile Disc) reproduction apparatus and a Blu-Ray disc reproduction apparatus.

Communication cable 3B is connected to input terminal Input 2 of input unit 9, and transmits an image signal between an external image source and projector 1 in accordance with the HDMI. Examples of the image source supplying an image signal in accordance with the HDMI specification (hereinafter also referred to as an HDMI signal) include an image source outputting a digital signal, such as a DVD reproduction apparatus and a Blu-Ray disc reproduction apparatus.

The analog transmission path includes a plurality of wired or wireless transmission paths 7A, 7B. The transmission paths each transmit a signal between an image source and projector 1. Examples of the image source include an image source outputting an analog signal, such as a PC (Personal Computer) and a VTR (Videotape Recorder).

Input terminal Input 3 is an RGB terminal, and corresponds to an RGB analog signal supplied from the PC. Input terminal Input 4 is, for example, a video terminal, and corresponds to a video signal supplied from the VTR.

For simplicity of explanation, it is assumed that a signal transmitted from each image source is an image signal. Although an audio signal is also transmitted together with the image signal, transmission of the audio signal and audio signal processing in projector 1 will not be described for simplicity of explanation.

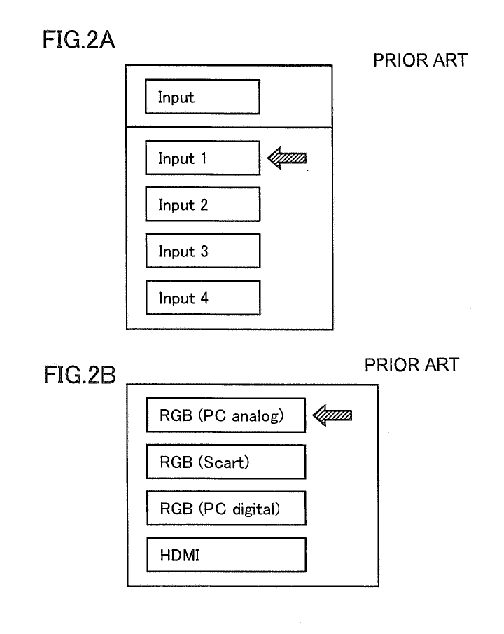

When the user desires to change an image displayed on projection screen SC in such a projector, an instruction to switch an input is input from remote controller 4 or the manipulation unit, via manipulation accepting unit 64, to projector 1. FIG. 2 is a view illustrating a conventional method of switching an input image signal.

When the instruction to switch an input described above is input, a control unit (not shown) of projector 1 activates an OSD (On Screen Display) generation unit to cause an input switching menu including a list of selection items as input switching targets to be displayed. For example, in the example of FIG. 2, an input terminal switching menu for selecting an input terminal is firstly displayed. In the input terminal switching menu, selection items (input terminals Input 1 to Input 4) as shown in FIG. 2A are listed.

If a user selects a desired input terminal (for example, Input 1) from among the input terminal switching menu using remote controller 4, the control unit further causes an image signal switching menu for selecting an input image signal (that is, an image source) to be displayed, for the selected input terminal Input 1. For example, as the image signal switching menu, a menu including a list of image signals that can be input to input terminal Input 1 as shown in FIG. 2B is displayed.

If the user selects a desired image signal (for example, the RGB analog signal (corresponding to the “RGB (PC analog)” in the drawing) from among the image signal switching menu using remote controller 4, and if the selected image signal is input from input terminal Input 1, the control unit causes an image based on the image signal (RGB analog signal) input to input terminal Input 1 to be projected.

On the other hand, if the selected image signal is not input from input terminal Input 1, the control unit generates an image signal representing a screen in which, for example, an “input terminal name” selected by the user and a message “no image signal is input” are displayed on a solid blue screen, and causes an image indicated by the image signal to be projected.

As described above, the conventional method of switching an input image signal causes a menu for selecting an input switching target to be displayed to allow the user to select a desired input terminal on the menu. Therefore, the user can know what image signal is input to the selected input terminal only after an image based on an image signal selected on the menu is projected. In addition, the user can know that no image signal is input to the selected input terminal only after the solid blue screen is displayed. Thus, in the conventional method of switching an input image signal, it is necessary to switch an input image signal while checking which image source can be used and what is displayed, causing a problem that the manipulation is complicated and inconvenient. In particular, such a problem is further significant in the case where the number of image sources that can be connected to a projector is increased as in recent years.

Accordingly, to solve such a problem, in a method of switching an input image signal in accordance with the embodiment of the present invention, an image based on an image signal selected in the past is held as a history image, and the history image is caused to be displayed in response to an instruction to switch an input from a user.

(Method of Switching Input Image Signal)

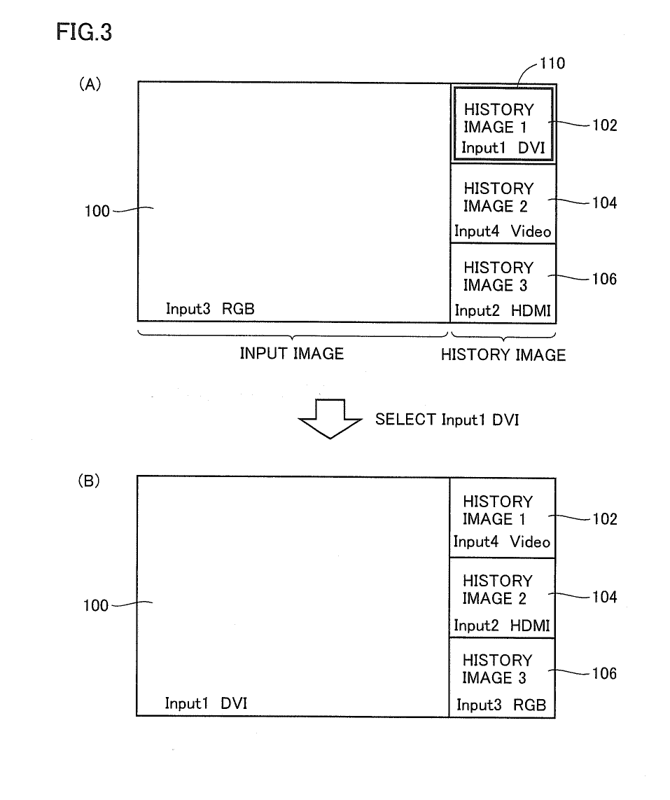

Hereinafter, the method of switching an input image signal in accordance with the embodiment of the present invention will be described with reference to FIGS. 3 to 6.

Firstly, as modes for displaying an image based on an image signal (hereinafter also referred to as display modes), projector 1 in accordance with the present embodiment has a “single-screen display mode” selecting one of the four image signals respectively input from input terminals Input 1 to Input 4 of input unit 9 and displaying an image based on the selected image signal, and a “history image display mode” displaying an image based on an image signal selected in the past as a history image.

Switching between the single-screen display mode and the history image display mode is performed by the control unit inside projector 1, based on a command to switch a display mode input from remote controller 4 or the manipulation unit via manipulation accepting unit 64. It is assumed that the command to switch a display mode includes the command to switch an input described above.

FIGS. 3(A) and 3(B) are views showing an example of images displayed by projector 1 in accordance with the present embodiment. The drawings show an example of display images when the history image display mode is performed.

Referring to FIG. 3(A), when the history image display mode is performed, a display region of a display unit (liquid crystal panel) of projector 1 is divided into a plurality of windows. The plurality of windows include one main window 100 as a screen having a relatively large size (hereinafter also referred to as a main screen) and three sub windows 102, 104, 106 as screens having a size smaller than that of the main screen (hereinafter also referred to as sub screens). The sizes and arrangement of main window 100 and sub windows 102 to 106, and the number of sub windows are not limited to the manner in FIG. 3(A).

In main window 100, an image based on a currently selected image signal (hereinafter also referred to as an “input image”) is displayed. As an example, it is assumed that an image based on an image signal corresponding to input terminal Input 3 (the RGB terminal) is displayed in main window 100.

In sub windows 102 to 106, history images as images based on image signals selected in the past are displayed. If an image signal selected in the past is moving image data, only a still image generated from the moving image data is displayed as a history image.

In the present embodiment, it is assumed that three sub windows 102 to 106 have the same size and are aligned vertically. It is also assumed that the history images displayed in sub windows 102 to 106 are arranged in order from a temporally old one (corresponding to a history image 1 in the drawing) to a temporally new one (corresponding to a history image 3 in the drawing).

Specifically, an image based on an image signal selected immediately before switching to the current input image (history image 3) is displayed in sub window 106, an image based on an image signal selected immediately before switching to history image 3 (a history image 2) is displayed in sub window 104, and an image based on an image signal selected immediately before switching to history image 2 (history image 1) is displayed in sub window 102. For example, it is assumed that an image based on an image signal from input terminal Input 2 (an HDMI terminal) is displayed in sub window 106, an image based on an image signal from input terminal Input 4 (the video terminal) is displayed in sub window 104, and an image based on an image signal from input terminal Input 1 (a DVI terminal) is displayed in sub window 102.

That is, in the example of FIG. 3(A), the input terminals have been selected in order from Input 1, Input 4, Input 2, to Input 3 in chronological order, and accordingly the input image signals are switched in order from the DVI signal, the video signal, the HDMI signal, to the RGB analog signal.

It is to be noted that, in each of main window 100 and sub windows 102 to 106, an image based on an image signal is displayed with an “input terminal name” corresponding to the image signal being displayed in a superimposed manner by an OSD function described later. Thereby, the user can intuitively know the correspondence between a history image displayed in the past and an input terminal.

Here, if the user desires to switch an input image, the user uses remote controller 4 or the manipulation unit to perform a manipulation to select a desired history image from among the three history images on the screen of FIG. 3(A). The manipulation can be performed, for example, by moving a cursor 110 displayed in a superimposed manner on the screen of FIG. 3(A) upward or downward by manipulating a “selection button” provided to remote controller 4 or the manipulation unit.

If the user performs the manipulation to select a history image, projector 1 selects an input terminal corresponding to the selected history image. Then, projector 1 causes an image based on an image signal from the selected input terminal to be displayed in main window 100, as an input image.

For example, if a manipulation to select history image 1 is performed on the screen of FIG. 3(A), projector 1 selects input terminal Input 1 (the DVI terminal) corresponding to history image 1 as an input terminal for the image. Thereby, as shown in FIG. 3(B), the image based on the image signal from input terminal Input 1 (the DVI terminal) is displayed in main window 100.

On this occasion, in sub windows 102 to 106, the history images displayed in the windows are updated in association with the switching of an input image signal described above. The history images are updated to newly include an input image immediately before the switching in the history images.

Specifically, as shown in FIG. 3(B), the image based on the image signal corresponding to input terminal Input 3 (the RGB terminal) selected immediately before the switching is displayed in sub window 106 as history image 3. In addition, history images 2, 3 immediately before the switching are changed to history images 1, 2, respectively. That is, in association with the input image immediately before the switching being displayed as history image 3, the image corresponding to the oldest history image 1 immediately before the switching is erased from the screen.

As described above, in the method of switching an input image signal in accordance with the present embodiment, an image displayed in the past is displayed as a history image. Thereby, the user can select an image to be displayed by an intuitive manipulation on the screen. As a result, an input image signal can be switched with easier manipulation, when compared with the conventional method of switching an input image signal that causes a menu for selecting an image signal as a switching target to be displayed to allow the user to select an input terminal on the menu.

Further, since a history image is displayed with an input terminal name of an image signal corresponding to the history image being displayed in a superimposed manner, the user can intuitively know the correspondence between an input terminal and an image signal, that is, what image signal is input to which input terminal. Therefore, comfortable operability can be achieved, when compared with the conventional method of switching an input image signal in which the user can know what image signal is input to the selected input terminal only after an image based on the image signal selected on the menu is projected.

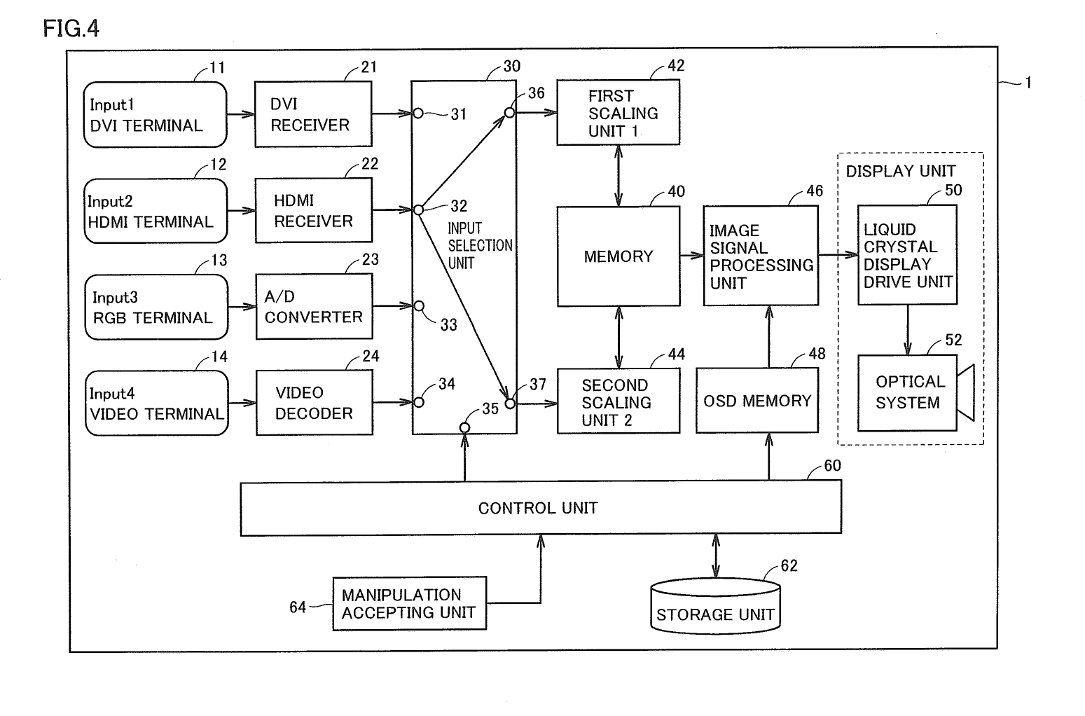

Next, a configuration of projector 1 for performing the method of switching an input image signal will be described with reference to FIGS. 4 to 6.

(Configuration of Projector)

FIG. 4 is a view illustrating a configuration of projector 1 in accordance with the embodiment of the present invention.

Referring to FIG. 4, projector 1 includes input terminals 11 to 14, a DVI receiver 21, an HDMI receiver 22, an A/D converter 23, a video decoder 24, an input selection unit 30, a memory 40, scaling units 42, 44, an image signal processing unit 46, an OSD memory 48, a liquid crystal display drive unit 50, an optical system 52, a control unit 60, a storage unit 62, and manipulation accepting unit 64.

Input terminals 11 to 14 correspond to input terminals Input 1 to Input 4 of input unit 9 shown in FIG. 1, respectively. Input terminal 11 corresponds to input terminal Input 1 (the DVI terminal), input terminal 12 corresponds to input terminal Input 2 (the HDMI terminal), input terminal 13 corresponds to input terminal Input 3 (the RGB terminal), and input terminal 14 corresponds to input terminal Input 4 (the video terminal).

DVI receiver 21 receives and processes a digital image signal (DVI signal) received at input terminal 11, and outputs the processed signal to input selection unit 30. Specifically, DVI receiver 21 has an authentication function and a decryption function in accordance with the HDCP (High-bandwidth Digital Content Protection). The HDCP is used to implement encryption of data transmitted in accordance with the DVI. This can prevent illegal copying of a content such as an image signal transmitted over the digital transmission path.

To protect transmission data and signals by the HDCP, firstly, a transmission side (the DVD reproduction apparatus) bilaterally communicates with a reception side (projector 1) to exchange information for mutual authentication. Based on the information, the transmission side authenticates the reception side. If the transmission side can authenticate the reception side as a result of the authentication, the transmission side encrypts a digital image signal using a key commonly owned beforehand, and transmits the encrypted digital image signal to the reception side via the digital transmission path. The reception side decrypts the encryption using the key shared beforehand. If the transmission side cannot authenticate the reception side, the transmission side rejects transmission of a digital image signal to the reception side, and the image signal is not transmitted to the reception side.

HDMI receiver 22 receives and processes an HDMI signal received at input terminal 12, and outputs the processed signal to input selection unit 30. HDMI receiver 22 has an authentication function and a decryption function in accordance with the HDCP, as with DVI receiver 21 described above.

A/D converter 23 performs A/D conversion on an RGB analog image signal received at input terminal 13, and outputs it as a digital image signal to input selection unit 30. This is performed to subject the image signal to various signal processing.

Video decoder 24 converts a received video signal to a component signal, and then performs image signal processing including A/D conversion processing on the component signal. Video decoder 24 outputs the processed signal to input selection unit 30.

Input selection unit 30 includes a first input portion 31 receiving the DVI signal output from DVI receiver 21, a second input portion 32 receiving the HDMI signal output from HDMI receiver 22, a third input portion 33 receiving the RGB analog signal output from A/D converter 23, and a fourth input portion 34 receiving the video signal output from video decoder 24. Further, input selection unit 30 includes a switching input portion 35 receiving a switching signal supplied from control unit 60, a first output terminal 36 to which the first scaling unit 42 is connected, and a second output terminal 37 to which the second scaling unit 44 is connected.

Input selection unit 30 selects one of four input portions 31 to 34 in accordance with the switching signal from control unit 60. Then, input selection unit 30 connects the selected input portion with the first and second output terminals 36, 37, and thereby supplies an image signal received by the input portion to the first and second scaling units 42, 44 via the first and second output terminals 36, 37, respectively.

The first scaling unit 42 performs processing for converting a resolution of an image represented by the image signal, using a resolution of the display unit (liquid crystal panel) in the single-screen display mode as a reference, in accordance with a preset desired size having a resolution not more than the reference. By the resolution conversion processing, the first scaling unit 42 generates image data representing an image for display having a resolution not more than the resolution of the display unit. The generated image data is stored in memory 40.

The second scaling unit 44 performs processing for converting the resolution of the image represented by the image signal, in accordance with a display size of the sub windows in the history image display mode. By the resolution conversion processing, the second scaling unit 44 generates image data representing a history image having a resolution corresponding to the display size of the sub windows. The generated image data is stored in memory 40.

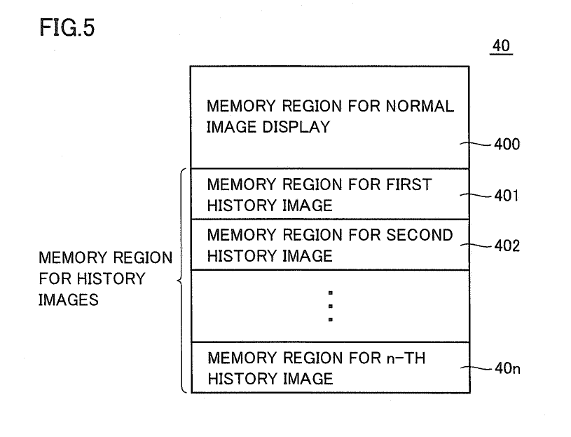

Memory 40 stores the image data for display output from the first scaling unit 42, and the image data for the history image output from the second scaling unit 44. FIG. 5 is a view illustrating a configuration of memory 40.

Referring to FIG. 5, memory 40 is divided into a plurality of memory regions. Specifically, memory 40 is divided into a memory region 400 in which image data representing an image for display in a normal display state (the single-screen display mode) is stored (hereinafter also referred to as a “memory region for normal image display”), and a memory region in which image data representing history images for display in the history image display mode are stored (hereinafter also referred to as a “memory region for history images”). The memory region for history images is further divided into n memory regions 401 to 40n (n is a natural number not less than two).

Image data for each frame is stored in memory region for normal image display 400. When the single-screen display mode is performed, image signal processing unit 46 (FIG. 4) performs image signal processing such as reading the image data for each frame written in memory region for normal image display 400 under predetermined conditions. The image signal processing includes frame rate conversion indicating the number of updates of rendering per second, and the like. The input image signal is subjected to such image signal processing, and is output as an image signal for a projection image.

On the other hand, image data of a still image representing a history image is stored in each of a memory region for a first history image 401 to a memory region for an n-th history image 40n. The image data for the history images are stored to be arranged in chronological order such that, for example, image data of a still image representing a temporally old history image is stored in memory region for the first history image 401, and image data of a still image representing a temporally new history image is stored in memory region for the n-th history image 40n.

When the history image display mode is performed, image signal processing unit 46 reads the image data for each frame written in memory region for normal image display 400, and reads the image data for history images written in the memory region for history images. On this occasion, image signal processing unit 46 reads image data for the newest history images in a predetermined number (for example, three) from the memory region for history images. As an example, if image data are stored in memory region for the first history image 401 to a memory region for a fourth history image 404 (not shown), image data for history images are read from memory region for the fourth history image 404, a memory region for a third history image 403 (not shown), and a memory region for a second history image 402. The read image data for history images are supplied to image signal processing unit 46 together with the image data for each frame.

Referring to FIG. 4 again, to process the image data read from memory 40 to be a signal suitable for display by the display unit described later, image signal processing unit 46 outputs an analog image signal obtained by performing various image signal processing and further performing D/A conversion on the image data.

Specifically, when the single-screen display mode is performed, image signal processing unit 46 performs γ correction converting a gradation value of the image data for each frame into a gradation value suitable for display by the display unit and color unevenness correction processing due to such as unevenness in brightness inherent in the liquid crystal panel of the display unit, and further performs D/A conversion.

In addition, when the history image display mode is performed, image signal processing unit 46 synthesizes a digital image signal for one frame to be displayed by the display unit, based on the image data for each frame and the image data for the predetermined number of (three) history images. Then, image signal processing unit 46 outputs an analog image signal obtained by performing γ correction in accordance with a gradation value of the digital image signal and color unevenness correction processing on the digital image signal, and further performing D/A conversion on the digital image signal.

In addition, image signal processing unit 46 has the OSD function of superimposing an input terminal name on an image represented by an image signal. In accordance with an instruction from control unit 60, image signal processing unit 46 reads, for example, an “input terminal name” from OSD memory 48, and superimposes it on an image signal. If no image signal is input to an input terminal, image signal processing unit 46 reads a screen in which, for example, an “input terminal name” and a message “no image signal is input” are displayed on a solid blue screen (hereinafter also referred to as a “no-signal screen”) from OSD memory 48, generates an image signal indicating the no-signal screen, and supplies it to liquid crystal display drive unit 50.

OSD memory 48 is a nonvolatile memory, and stores screens representing manipulation states of projector 1 used for OSD such as the “input terminal name” and “no-signal screen”, various character patterns, and the like.

Liquid crystal display drive unit 50, optical system 52, and a lamp (not shown) correspond to a “display unit” for displaying an image on projection screen SC under the control of control unit 60 in accordance with an image signal output from image signal processing unit 46.

An operation of the display unit will be described. The lamp as an illumination apparatus includes, for example, an extra high pressure mercury lamp, a metal halide lamp, and a xenon lamp. The lamp is removably attached to projector 1 via a connector. Substantially parallel light is emitted from the lamp to liquid crystal display drive unit 50.

Liquid crystal display drive unit 50 includes an optical system including a lens and a prism not shown, and R, G, and B liquid crystal panels. In liquid crystal display drive unit 50, the light from the lamp passing through an inside lens system not shown enters the R, G, and B liquid crystal panels such that uniform light amount distribution is obtained. Of the light entering through the lens system, light in a blue wavelength band (hereinafter referred to as “B light”), light in a red wavelength band (hereinafter referred to as “R light”), and light in a green wavelength band (hereinafter referred to as “G light”) enter the R, G, and B liquid crystal panels, respectively, as substantially parallel light. The liquid crystal panels are driven in accordance with image signals corresponding to R, G, and B supplied from image signal processing unit 46, and modulate the light in accordance with a drive state thereof. The R light, G light, and B light modulated by the liquid crystal panels are color-synthesized by a dichroic prism, and thereafter projected on projection screen SC in an enlarged manner by a projection lens. The projection lens includes a lens group for forming an image of the projected light on projection screen SC, and an actuator for adjusting a zoom state and a focus state of the projection image by changing a portion of the lens group in an optical axis direction.

Control unit 60 is a CPU (Central Processing Unit). Control unit 60 exchanges signals with each unit via a bus line not shown, and controls an operation of each unit in line with a manipulation signal from manipulation accepting unit 64.

Storage unit 62 is configured, for example, with a data-rewritable nonvolatile memory such as a flash memory. Storage unit 62 stores various control programs for instructing and controlling the operation of projector 1, and the like. It is to be noted that the control programs include an “input switching program” as a program for switching an input image signal.

If a manipulation is performed on the manipulation unit or remote controller 4, manipulation accepting unit 64 accepts the manipulation and sends a manipulation signal serving as a trigger for various operations to control unit 60.

(As to Operation of Projector)

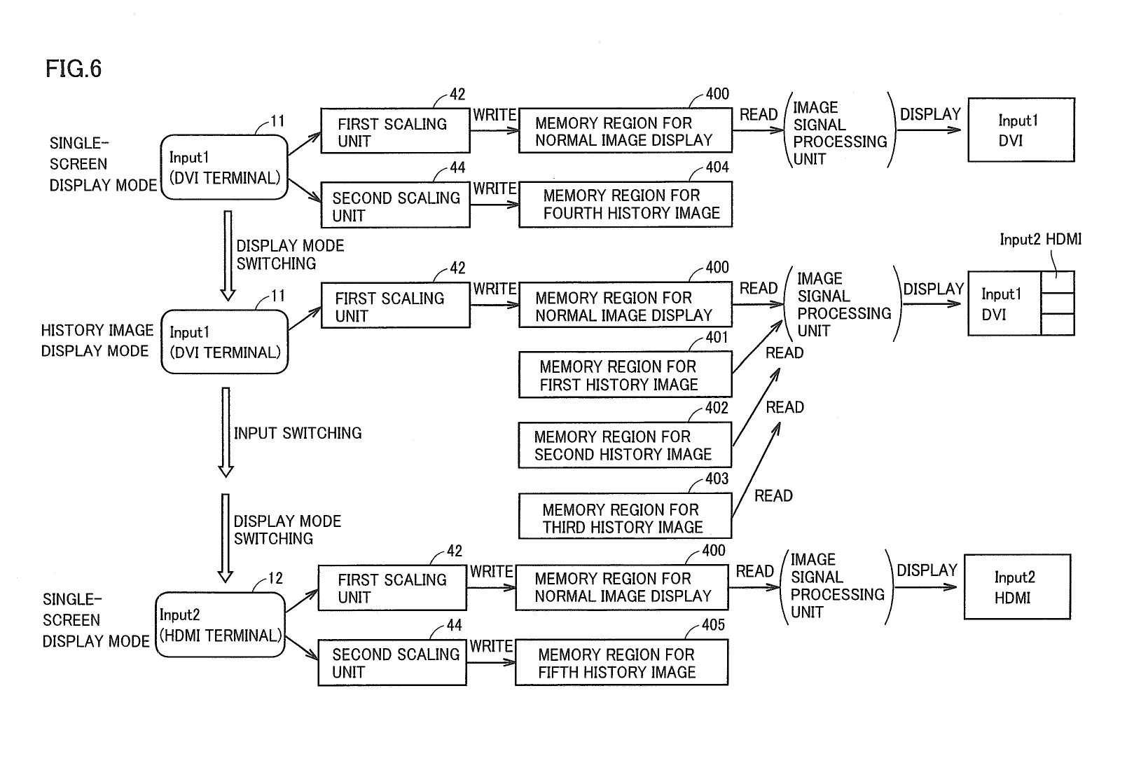

FIG. 6 is a view illustrating an operation of projector 1 in each of the single-screen display mode and the history image display mode.

Referring to FIG. 6, it is assumed that, when the single-screen display mode is performed, input selection unit 30 (FIG. 4) selects input terminal Input 1 (the DVI terminal). The first scaling unit 42 performs the resolution conversion processing described above on an image signal (DVI signal) received from input terminal Input 1, and thereby generates image data representing an image for display having a resolution not more than the resolution of the display unit. The generated image data is written in memory region for normal image display 400 of memory 40.

The second scaling unit 44 performs the resolution conversion processing on the image signal (DVI signal) received from input terminal Input 1, and thereby generates image data representing a history image having a resolution corresponding to the display size of the sub windows. The generated image data is written in the memory region for history images (for example, memory region for the fourth history image 404) of memory 40.

Image signal processing unit 46 performs image signal processing such as reading the image data for each frame written in memory region for normal image display 400 under predetermined conditions, and thereby outputs the image data to the display unit as an image signal for a projection image. Thus, an image based on the image signal from input terminal Input 1 (the DVI terminal) is displayed on projection screen SC.

Subsequently, when the display mode is switched from the single-screen display mode to the history image display mode based on a command to switch the display mode input from remote controller 4 or the manipulation unit via manipulation accepting unit 64, the first scaling unit 42 performs the resolution conversion processing on the image signal (DVI signal) received from input terminal Input 1, and thereby generates image data representing an image for display having a resolution corresponding to the display size of the main window. The generated image data is written in memory region for normal image display 400 of memory 40.

Image signal processing unit 46 reads the image data for each frame written in memory region for normal image display 400, and reads image data for the newest history images in the predetermined number (three) from the memory region for history images. In the example of FIG. 6, image signal processing unit 46 reads image data for a history image from each of memory region for the first history image 401 to memory region for the third history image 403.

Then, image signal processing unit 46 synthesizes a digital image signal for one frame to be displayed by the display unit, based on the image data for each frame and the image data for the predetermined number of (three) history images. Image signal processing unit 46 further superimposes input terminal names read from OSD memory 48 on the synthesized image signal. Thereby, on projection screen SC, the image based on the image signal from input terminal Input 1 is displayed in the main window, and a history image is displayed in each of the three sub windows.

Here, it is assumed that the user performs a manipulation to select one of the three history images as an input image as a switching target, using remote controller 4 or the manipulation unit. For example, if a history image based on an image signal from input terminal Input 2 (the HDMI terminal) is selected on the screen, input selection unit 30 selects input terminal Input 2 corresponding to the selected history image. Thereby, as illustrated in FIGS. 3(A) and 3(B), an image based on the image signal from input terminal Input 2 is displayed in the main window. In addition, the input image immediately before the switching, that is, the image based on the image signal corresponding to input terminal Input 1, is newly displayed in a sub window as a history image.

Then, when the display mode is switched from the history image display mode to the single-screen display mode based on a command to switch the display mode input from remote controller 4 or the manipulation unit via manipulation accepting unit 64, the first scaling unit 42 performs the resolution conversion processing described above on the image signal (HDMI signal) received from input terminal Input 2 (the HDMI terminal), and thereby generates image data representing an image for display having a resolution not more than the resolution of the display unit. The generated image data is written in memory region for normal image display 400 of memory 40.

The second scaling unit 44 performs the resolution conversion processing on the image signal (HDMI signal) received from input terminal Input 2, and thereby generates image data representing a history image having a resolution corresponding to the display size of the sub windows. The generated image data is written in the memory region for history images (a memory region for a fifth history image 405) of memory 40.

Image signal processing unit 46 performs image signal processing such as reading the image data for each frame written in memory region for normal image display 400 under predetermined conditions, and thereby outputs the image data to the display unit as an image signal for a projection image. Thus, an image based on the image signal corresponding to input terminal Input 2 (the HDMI terminal) is displayed on projection screen SC.

[Modification]

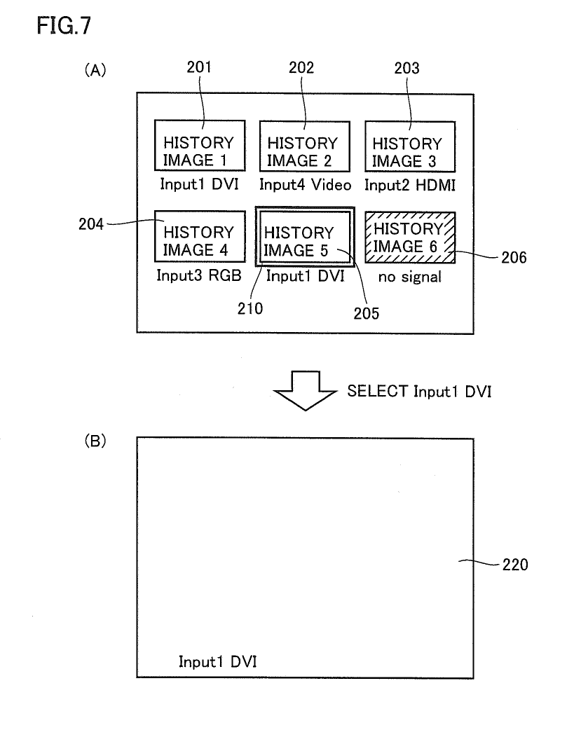

FIGS. 7(A) and 7(B) are views showing another example of images displayed by projector 1 in accordance with the present embodiment. FIG. 7(A) shows an example of a display image when the history image display mode is performed. FIG. 7(B) shows an example of a display image when the single-screen display mode is performed.

Referring to FIG. 7(A), when the history image display mode is performed, the display region of the display unit of projector 1 is divided into a plurality of windows. In the present modification, the plurality of windows include six windows 201 to 206. The size and arrangement of windows 201 to 206, and the number of windows are not limited to the manner in FIG. 7(A).

In each of windows 201 to 206, a history image is displayed. In the present modification, it is assumed that six windows 201 to 206 have the same size, and that the history images displayed in windows 201 to 206 are arranged in order from a temporally old one (corresponding to history image 1 in the drawing) to a temporally new one (corresponding to a history image 6 in the drawing). If an image signal is moving image data, only a still image generated from the moving image data is displayed as a history image.

Specifically, an image based on an image signal selected immediately before switching to a current input image (history image 6) is displayed in window 206, an image based on an image signal selected immediately before switching to history image 6 (a history image 5) is displayed in window 205, and an image based on an image signal selected immediately before switching to history image 5 (a history image 4) is displayed in window 204. In addition, an image based on an image signal selected immediately before switching to history image 4 (history image 3) is displayed in window 203, an image based on an image signal selected immediately before switching to history image 3 (history image 2) is displayed in window 202, and an image based on an image signal selected immediately before switching to history image 2 (history image 1) is displayed in window 201.

For example, it is assumed that the “no-signal screen” indicating that no image signal is input to an input terminal is displayed in window 206, an image based on an input image signal from input terminal Input 1 (the DVI terminal) is displayed in window 205, and an image based on an input image signal from input terminal Input 3 (the RGB terminal) is displayed in window 204. It is also assumed an image based on an input image signal from input terminal Input 2 (the HDMI terminal) is displayed in window 203, an image based on an input image signal from input terminal Input 4 (the video terminal) is displayed in window 202, and an image based on an input image signal from input terminal Input 1 (the DVI terminal) is displayed in window 201.

In each of windows 201 to 206, an image based on an image signal is displayed with an “input terminal name” corresponding to the image signal being displayed in a superimposed manner by the OSD function described above. In addition, if no signal is input to an input terminal selected in the past, the “no-signal screen” is displayed as a history image. Thereby, the user can intuitively know the correspondence between a history image displayed in the past and an input terminal. Therefore, comfortable operability can be achieved, when compared with the conventional method of switching an input image signal in which the user can know what image signal is input to the selected input terminal only after an image based on the image signal selected on the menu is projected.

Here, if the user desires to switch an input image, the user uses remote controller 4 or the manipulation unit to perform a manipulation to select a desired history image from among the six history images on the screen of FIG. 7(A). The manipulation can be performed, for example, by moving a cursor 210 displayed in a superimposed manner on the screen of FIG. 7(A) upward, downward, to the right, or to the left by manipulating the “selection button” provided to remote controller 4 or the manipulation unit. If the manipulation to select a history image is performed, projector 1 selects an input terminal corresponding to the selected history image. If the input terminal is selected, the display mode of projector 1 is switched from the history image display mode to the single-screen display mode.

For example, if a manipulation to select history image 5 is performed on the screen of FIG. 7(A), projector 1 selects input terminal Input 1 (the DVI terminal) corresponding to history image 5 as an input terminal for the image. Thereby, when the display mode is switched to the single-screen display mode as shown in FIG. 7(B), the image based on the image signal from input terminal Input 1 (the DVI terminal) is displayed on an entire screen.

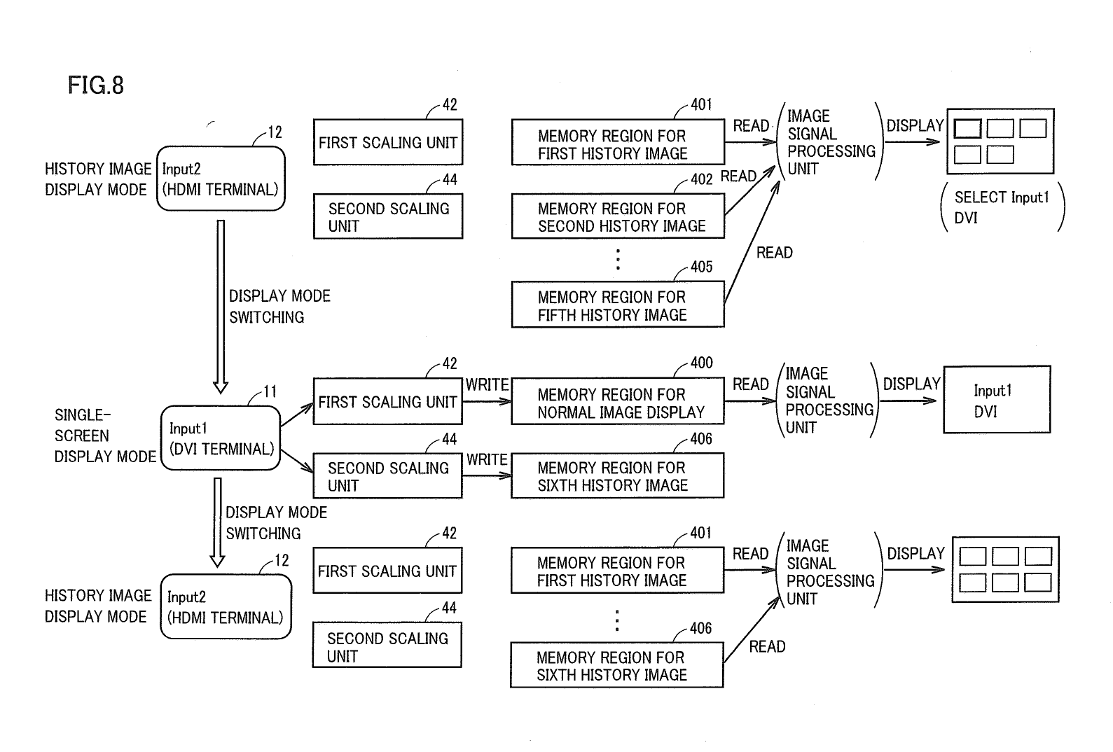

Next, an operation of projector 1 for performing the method of switching an input image signal in accordance with the present modification will be described with reference to FIG. 8. Since the configuration of the projector in accordance with the present modification is identical to the configuration of projector 1 illustrated in FIG. 4, the detailed description thereof will not be repeated.

(As to Operation of Projector)

FIG. 8 is a view illustrating an operation of projector 1 in each of the single-screen display mode and the history image display mode.

Referring to FIG. 8, when the history image display mode is performed, image signal processing unit 46 (FIG. 4) reads image data for the newest history images in a plural number (up to six). In the example of FIG. 8, image signal processing unit 46 reads image data for a history image from each of memory region for the first history image 401 to memory region for the fifth history image 405.

Then, image signal processing unit 46 synthesizes a digital image signal for one frame to be displayed by the display unit, based on the image data for the five history images. Image signal processing unit 46 further superimposes input terminal names read from OSD memory 48 on the synthesized image signal. Thereby, on projection screen SC, a history image is displayed in each of the five sub windows.

Here, it is assumed that the user performs a manipulation to select one of the five history images as an input image as a switching target, using remote controller 4 or the manipulation unit. For example, if a history image based on an image signal corresponding to input terminal Input 1 (the DVI terminal) is selected on the screen, input selection unit 30 selects input terminal Input 1 (the DVI terminal) corresponding to the selected history image. Thereby, as illustrated in FIGS. 7(A) and 7(B), the display mode of projector 1 is switched from the history image display mode to the single-screen display mode.

When the display mode is switched to the single-screen display mode, the first scaling unit 42 performs the resolution conversion processing described above on the image signal (DVI signal) received from input terminal Input 1 (the DVI terminal), and thereby generates image data representing an image for display having a resolution not more than the resolution of the display unit. The generated image data is written in memory region for normal image display 400 of memory 40.

The second scaling unit 44 performs the resolution conversion processing on the image signal (DVI signal) received from input terminal Input 1 (the DVI terminal), and thereby generates image data representing a history image having a resolution corresponding to the display size of the windows (FIG. 7(A)). The generated image data is written in the memory region for history images (a memory region for a sixth history image 406) of memory 40.

Image signal processing unit 46 performs image signal processing such as reading the image data for each frame written in memory region for normal image display 400 under predetermined conditions, and thereby outputs the image data to the display unit as an image signal for a projection image. Thus, an image based on the image signal corresponding to input terminal Input 1 (the DVI terminal) is displayed on projection screen SC.

Thereafter, when the display mode is switched from the single-screen display mode to the history image display mode based on a command to switch the display mode input from remote controller 4 or the manipulation unit via manipulation accepting unit 64, image signal processing unit 46 reads image data for the newest six history images from the memory region for history images. In the example of FIG. 8, image signal processing unit 46 reads image data for a history image from each of memory region for the first history image 401 to memory region for the sixth history image 406. Then, image signal processing unit 46 synthesizes a digital image signal for one frame to be displayed by the display unit, based on the image data for the six history images. Image signal processing unit 46 further superimposes input terminal names read from OSD memory 48 on the synthesized image signal. Thereby, on projection screen SC, a history image is displayed in each of the six sub windows.

As has been described above, in the method of switching an input image signal by the image display apparatus in accordance with the embodiment of the present invention, an image displayed in the past is displayed as a history image, and thus the user can select an image to be displayed by an intuitive manipulation on the screen. As a result, an input image signal can be switched with easier manipulation, when compared with the conventional method of switching an input image signal that causes a menu for selecting an image signal as a switching target to be displayed to allow the user to select an input terminal on the menu.

Further, since a history image is displayed with an input terminal name of an image signal corresponding to the history image being displayed in a superimposed manner, the user can intuitively know the correspondence between an input terminal and an image signal, that is, what image signal is input to which input terminal. Therefore, comfortable operability can be achieved, when compared with the conventional method of switching an input image signal in which the user can know what image signal is input to the selected input terminal only after an image based on the image signal selected on the menu is projected.

Although a liquid crystal projector has been employed as the projector in the present embodiment, the present invention is not limited thereto. For example, the technique of the present invention may be employed in a projector of other type such as a DLP (Digital Light Processing) (registered trademark) projector.

It should be understood that the embodiment disclosed herein is illustrative and non-restrictive in every respect. The scope of the present invention is defined by the scope of the claims, rather than the description above, and is intended to include any modifications within the scope and meaning equivalent to the scope of the claims.

What is claimed is:

1. An image display apparatus which displays an image represented by an image signal, comprising:
a plurality of input terminals which accept a plurality of image signals externally supplied, respectively;
a selection unit which selects at least one input terminal from among said plurality of input terminals;
a display unit which displays an image based on an image signal from the input terminal selected by said selection unit;
a history image holding unit which holds an image based on an image signal from an input terminal selected by said selection unit in the past as a history image; and
a history image display unit which causes said display unit to display said history image held in said history image holding unit.

2. The image display apparatus according to claim 1, wherein said history image display unit causes the image based on the image signal from the input terminal currently selected by said selection unit to be displayed in a predetermined display region of a plurality of display regions, and causes said history image to be displayed in a remaining display region of said plurality of display regions other than said predetermined display region.

3. The image display apparatus according to claim 1, wherein said history image display unit causes at least one said history image held in said history image holding unit to be displayed to be arranged in accordance with order of display in said display unit.

4. The image display apparatus according to claim 1, wherein said history image display unit causes each said history image to be displayed with information related to an input terminal corresponding to the history image being superimposed thereon.

5. The image display apparatus according to claim 1, further comprising:
a manipulation unit which accepts a manipulation to select an input terminal from among said plurality of input terminals; and
an input switching unit which causes said selection unit, when the manipulation to select an input terminal is accepted by said manipulation unit on a screen in which said history image is displayed by said display unit, to select the selected input terminal.

6. The image display apparatus according to claim 1, wherein, when no image signal is input to the input terminal selected by said selection unit in the past, said history image display unit causes said display unit to display an image indicating such a state.
